(19) United States
(12) Patent Application Publication
(10) Pub. No.: US 2022/0171112 A1
(43) Pub. Date: Jun. 2, 2022

(54) IMAGE DISPLAY APPARATUS, IMAGE DISPLAY METHOD, AND HEAD-MOUNTED DISPLAY

(71) Applicant: SONY GROUP CORPORATION, TOKYO (JP)

(72) Inventor: SATOSHI NAKANO, TOKYO (JP)

(21) Appl. No.: 17/593,491

(22) PCT Filed: Mar. 18, 2020
(86) PCT No.: PCT/JP2020/011923

§ 371 Date: Sep. 20, 2021

(30) Foreign Application Priority Data
Mar. 29, 2019 (JP) 2019-068262

(51) Int. Cl. G02B 5/32; G02B 27/30; G02B 27/01

(52) U.S. Cl. CPC G02B 5/32; G02B 27/30; G02B 27/0172; G02B 26/10; G02B 2027/0123; G02B 2027/0178; G02B 2027/0174

(57) ABSTRACT

An image display apparatus (100) according to an embodiment of the present technology includes a first optical element (20) and a second optical element (30). A first light beam and a second light beam having optical characteristics different from each other simultaneously enter the first optical element (20). A third light beam emitted from the first optical element (20) and corresponding to the first light beam and a fourth light beam emitted from the first optical element (20) at an angle different from an angle of the third light beam and corresponding to the second light beam (30) enter the second optical element (30). The second optical element (30) concentrates the third light beam and the fourth light beam at pupil locations different from each other.

### TECHNICAL FIELD

The present technology relates to an image display apparatus of a retina scanning type, an image display method, and a head-mounted display.

### BACKGROUND ART

In recent years, image display apparatuses of a retina scanning type have been developed. For example, Patent Literature 1 has disclosed a head-mounted display including a scan mirror that scans a plurality of light beams having different wavelengths and a holographic transflector having a multi-layer structure that reflects each of the plurality of light beams scanned by the scan mirror at an angle depending on its wavelength. It is described that the eye-box is enlarged because each light beam is emitted toward a different pupil location with this configuration.

### CITATION LIST

### Patent Literature

Patent Literature 1: Japanese Unexamined Patent Application Publication No. 2016-517036

### DISCLOSURE OF INVENTION

### Technical Problem

In the technology described in Patent Literature 1, the angle of the scan of the scan mirror, which enables the light beam having each wavelength to be concentrated at the pupil by the holographic transflector of each layer to have the same angle of view (angle when it enters the pupil), differs for each light beam. It is thus necessary to individually adjust the modulation timing of the light beam having each wavelength such that images formed by light beams having the respective wavelengths match with each other at different pupil locations, for example, to draw a partial region of an image formed by one light beam while the output of the other light beam is attenuated (or stopped). Thus, it is necessary to shift the modulation timing of each light source for image generation in a manner that depends on each pupil location, which makes the image generation process complicated.

In view of the above-mentioned circumstances, it is an object of the present technology to provide an image display apparatus, an image display method, and a head-mounted display by which the eye-box can be enlarged without the need for modulation of the light source depending on the pupil location.

### Solution to Problem

An image display apparatus according to an embodiment of the present technology includes a first optical element and a second optical element.

A first light beam and a second light beam having optical characteristics different from each other simultaneously enter the first optical element.

A third light beam emitted from the first optical element and corresponding to the first light beam and a fourth light beam emitted from the first optical element at an angle different from an angle of the third light beam and corresponding to the second light beam enter the second optical element. The second optical element concentrates the third light beam and the fourth light beam at pupil locations different from each other.

In accordance with the image display apparatus, the relationships between the incident positions or incident angles of the first light beam and the second light beam on the first optical element and the angles of view of the third light beam and the fourth light beam emitted from the second optical element are identical. Accordingly, the third light beam and the fourth light beam can be concentrated at different pupil locations without the need for modulation of the first light beam and the second light beam.

The first optical element may include at least one optical element that collimates the first light beam and the second light beam, deflects the first light beam as the third light beam, and deflects the second light beam as the fourth light beam.

The first light beam and the second light beam may have wavelengths different from each other. In this case, the first optical element and the second optical element may include the optical element having wavelength selectivity.

The first light beam and the second light beam may have polarization characteristics different from each other. In this case, the first optical element and the second optical element may include the optical element having polarization selectivity.

The optical element may be reflective.

The first optical element and the second optical element may be hologram lenses.

The first optical element and the second optical element may include a first deflection reflection layer and a second deflection reflection layer. The first deflection reflection layer has deflection selectivity to the first light beam and the second deflection reflection layer has deflection selectivity to the second light beam.

The first optical element may include an optical element that a fifth light beam having an optical characteristic different from the optical characteristics of the first light beam and the second light beam enters and that causes a sixth light beam corresponding to the fifth light beam to be emitted at an angle different from the angles of the third light beam and the fourth light beam. In this case, the second optical element includes a deflection lens element that concentrates the third light beam, the fourth light beam, and the sixth light beam at the pupil locations different from each other.

The image display apparatus may further include an optical engine that emits the first light beam and the second light beam toward the first optical element at a predetermined timing.

The optical engine may include a first light source and a second light source.

The first light source emits, as the first light beam, a laser light beam having a first wavelength as a center wavelength.

The second light source emits, as the second light beam, a laser light beam having a second wavelength different from the first wavelength as a center wavelength.

A difference between the first wavelength and the second wavelength may be 50 nm or less.

The optical engine may include a light source that emits a single-wavelength laser light beam having polarization characteristics divisible into a first polarized component and a second polarized component by the first optical element.

The first polarized component and the second polarized component may be linearly polarized light beams orthogonal to each other or may be circularly polarized light beams opposite in rotational direction to each other.

The optical engine may include a scan mirror that scans the first light beam and the second light beam on the first optical element.

The image display apparatus may further include a light transmitting member that transmits the third light beam and the fourth light beam to the second optical element from the first optical element.

An image display apparatus according to another embodiment of the present technology includes a first optical element and a second optical element.

The first optical element includes a plurality of optical elements that diffracts each of incident light beams at a different angle in a manner that depends on an incident angle.

A plurality of diffracted light beams each emitted from the first optical element at a different angle enters the second optical element, and the second optical element concentrates each of the plurality of diffracted light beams at a different pupil location.

An image display method according to an embodiment of the present technology includes:

causing a first light beam and a second light beam having optical characteristics different from each other to simultaneously enter a first optical element, to thereby form a third light beam emitted from the first optical element and corresponding to the first light beam and a fourth light beam emitted from the first optical element at an angle different from an angle of the third light beam and corresponding to the second light beam; and

causing the third light beam and the fourth light beam to enter a second optical element, to thereby concentrate the third light beam and the fourth light beam at pupil locations different from each other.

A head-mounted display according to an embodiment of the present technology includes an optical engine, a first optical element, and a display unit.

The optical engine emits a first light beam and a second light beam having optical characteristics different from each other.

The first light beam and the second light beam simultaneously enter a first optical element.

The display unit includes a second optical element that a third light beam emitted from the first optical element and corresponding to the first light beam and a fourth light beam emitted from the first optical element at an angle different from an angle of the third light beam and corresponding to the second light beam enter and concentrates the third light beam and the fourth light beam at pupil locations different from each other.

### Advantageous Effects of Invention

In accordance with the present technology, the eye-box can be enlarged without the need for modulation of the light source depending on the pupil location.

It should be noted that the effects described here are not necessarily limitative and any effect described in the present disclosure may be provided.

### BRIEF DESCRIPTION OF DRAWINGS

FIG. 1 A schematic configuration diagram showing an image display apparatus according to a first embodiment of the present technology.

FIG. 2 A diagram describing diffraction characteristics of a first optical element in the image display apparatus.

FIG. 3 A schematic diagram showing an example of a spot position of each reproduction image light beam projected onto an eyeball.

FIG. 4 A schematic configuration diagram showing an image display apparatus according to a comparison example.

FIG. 5 A perspective view of an overall head-mounted display according to the embodiment of the present technology.

FIG. 6 A schematic configuration diagram showing an image display apparatus according to a second embodiment of the present technology.

FIG. 7 A diagram describing diffraction characteristics of a first optical element in the image display apparatus.

FIG. 8 A schematic diagram showing another example of the spot position of each reproduction image light beam projected onto the eyeball.

FIG. 9 A schematic diagram showing still another example of the spot position of each reproduction image light beam projected onto the eyeball.

FIG. 10 A schematic configuration diagram showing an image display apparatus according to a third embodiment of the present technology.

FIG. 11 A schematic configuration diagram showing an image display apparatus according to a fourth embodiment of the present technology.

FIG. 12 An explanatory diagram showing an example of deflection characteristics of light beams emitted from an optical engine in the image display apparatus.

FIG. 13 An explanatory diagram showing another example of the deflection characteristics of the light beams emitted from the optical engine in the image display apparatus.

FIG. 14 A schematic configuration diagram showing an image display apparatus according to a fifth embodiment of the present technology.

FIG. 15 A diagram describing diffraction characteristics of a first optical element in the image display apparatus.

### MODE(S) FOR CARRYING OUT THE INVENTION

Hereinafter, embodiments according to the present technology will be described with reference to the drawings.

### First Embodiment

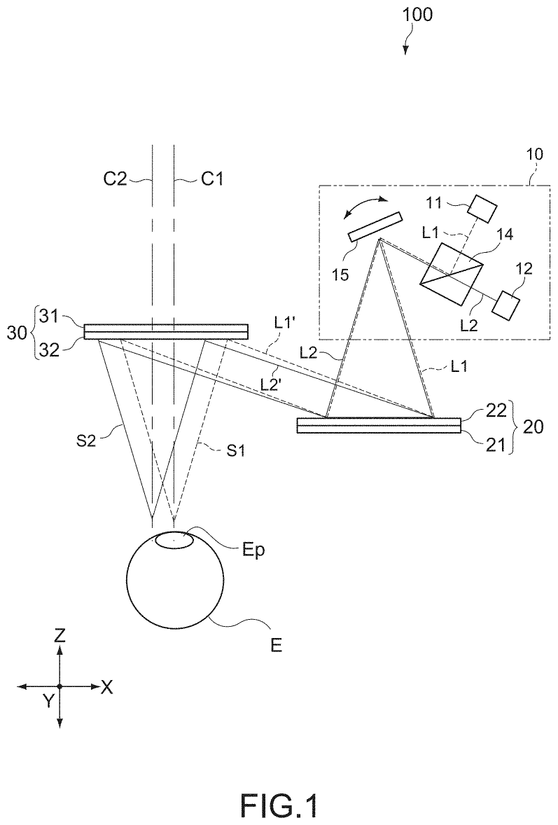

FIG. 1 is a schematic configuration diagram showing an image display apparatus 100 according to a first embodiment of the present technology.

[Overall Configuration]

As shown in FIG. 1, the image display apparatus 100 according to this embodiment is an image display apparatus of a retina scanning type that projects a light beam for image formation emitted from an optical engine 10 onto different pupil locations on an eyeball E of an observer via a first optical element 20 and a second optical element 21.

The image display apparatus 100 includes a first optical element 20 and a second optical element 30. A light beam L1 (first light beam) and a light beam L2 (second light beam) having optical characteristics different from each other simultaneously enter the first optical element 20. A light beam L1′ (third light beam) corresponding to the light beam L1 and emitted from the first optical element 20 and a light beam L2′ (fourth light beam) corresponding to the light beam L2 and emitted from the first optical element 20 at an angle different from that of the light beam L1′ enter the second optical element 30.

The second optical element 30 concentrates the light beam L1′ and the light beam L2′ at pupil locations different from each other.

(Optical Engine)

The optical engine 10 includes a first light source 11 that emits the light beam L1 and a second light source 12 that emits the light beam L2. Laser diodes are used for the first light source 11 and the second light source 12. In this embodiment, the first light source 11 emits a laser light beam having a wavelength λ1 (first wavelength) as the center wavelength as the light beam L1 and the second light source 12 emits a laser light beam having a wavelength λ2 (second wavelength) different from the wavelength λ1 as the center wavelength as the light beam L2. A wavelength longer than the wavelength λ1 is selected as the wavelength λ2, though not limited thereto. A shorter wavelength may be selected.

The light beams L1 and L2 may be continuous laser light beams or may be pulsed laser light beams. The wavelengths λ1 and λ2 are not particularly limited as long as they are wavelengths of visible light, and, for example, wavelengths of a red, blue, green, or another color are employed. In particular, in order to enlarge the eye-box, it is favorable that the wavelength λ1 and the wavelength λ2 are wavelengths of colors similar to each other. Accordingly, color-fixed images not depending on the pupil location can be presented to the observer.

In this embodiment, any two wavelengths of a wavelength range (approximately 600 nm to 780 nm) of red colors are employed as both the wavelength λ1 and the wavelength λ2. A difference between the wavelength λ1 and the wavelength λ2 is not particularly limited, though it is preferable that it is, for example, 50 nm or less in view of the fact that the color of the image changes depending on the pupil location.

The optical engine 10 further includes a dichroic mirror 14 that combines the light beam L1 and the light beam L2 and a scan mirror 15 that scans the light beam L1 and the light beam L2 on the first optical element 20.

The dichroic mirror 14 is an optical element that reflects the light beam L1 and allows the light beam L2 to pass therethrough, to thereby combine the light beam L1 and the light beam L2. The scan mirror 15 is, for example, an MEMS device fabricated by using a micro electro mechanical systems (MEMS) technology and scans the light beam L1 and the light beam L2 multi-dimensionally, to thereby form a two-dimensional or three-dimensional image projected onto the eyeball E of the observer. The type of image is not particularly limited and typically includes characters, symbols, figures, and/or the like.

The optical engine 10 controls driving of the first light source 11, the second light source 12, and the scan mirror 15 on the basis of a command from a controller (not shown).

It should be noted that the optical engine 10 is not limited to the above example, and, for example, a computer-generated hologram (CGH) optical system using a spatial light modulator (SLM) may be employed as the optical engine 10. Moreover, although the optical engine 10 is typically configured to simultaneously emit the light beam L1 and the light beam L2 for enlarging the eye-box, the optical engine 10 may be configured to emit only either one of the light beam L1 and the light beam L2 in a case of performing eye tracking control to follow the pupil location of the eyeball E and project image light. In short, the optical engine 10 may be configured to simultaneously emit the light beam L1 and the light beam L2 at only a predetermined timing such as a timing of performing a display mode to enlarge the eye-box.

(First Optical Element)

The first optical element 20 includes at least one optical element that collimates the light beam L1 and the light beam L2, deflects the light beam L1 as the light beam L1′, and deflects the light beam L2 as the light beam L2′. In this embodiment, the first optical element 20 is a hologram lens that selectively diffracts each of the light beam L1 and the light beam L2.

The first optical element 20 is constituted by a laminated film including a deflection reflection layer 21 (first deflection reflection layer) that the light beam L1 enters and that emits the light beam L1′ and a deflection reflection layer (second deflection reflection layer) that the light beam L2 enters and that emits the light beam L2′. That is, the deflection reflection layer 21 has deflection selectivity to the light beam L1 and the deflection reflection layer 22 has deflection selectivity to the light beam L2.

The order of stacking of the respective deflection reflection layers 21 and 22 is not limited to the example shown in the figure, and can be arbitrarily set. Alternatively, the first optical element 20 may be constituted by a single deflection reflection layer having the functions of the respective deflection reflection layers 21 and 22.

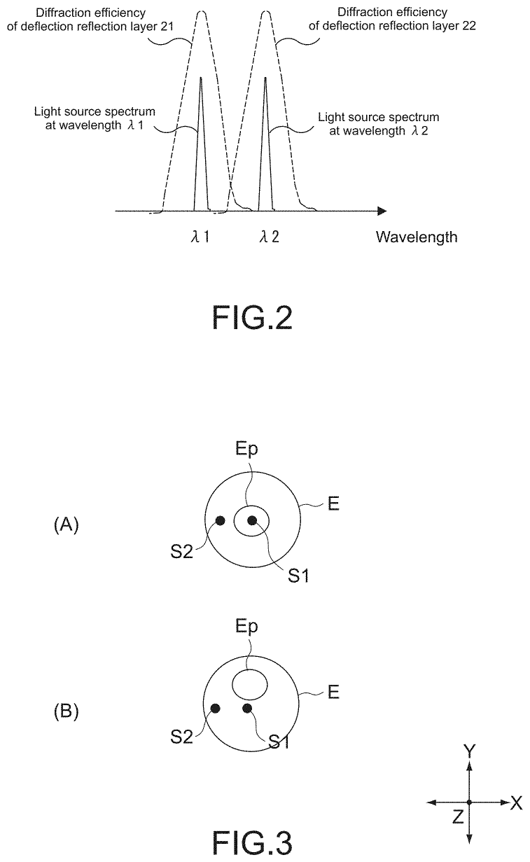

FIG. 2 is a diagram describing diffraction characteristics of the deflection reflection layers 21 and 22 to the light beams L1 and L2. As shown in the figure, the deflection reflection layer 21 is a reflective hologram having wavelength selectivity to provide highest diffraction efficiency to the light beam L1 having the wavelength λ1. On the other hand, the deflection reflection layer 21 is a reflective hologram having wavelength selectivity to provide highest diffraction efficiency to the light beam L2 of the wavelength λ2.

It should be noted that collimating the light beams L1 and L2 refers to performing adjustment such that the light beams L1 and L2 scanned by the scan mirror 15 are parallel to each other. Accordingly, each of the light beams L1 and L2 can be stably polarized or diffracted by the first optical element 20 at a desired angle. For example, an optical element such as a lens layer is added to the surface of the first optical element 20 for collimation of the light beam L1 and the light beam L2. Alternatively, another optical element such as a collimator lens may be disposed on the optical path between the scan mirror 15 and the first optical element 20. Such collimation may be omitted in a case where the optical path from the optical engine 10 to the first optical element 20 is relatively short and disturbance of convergence (radiation) of the light beams L1 and L2 is not a problem.

Moreover, the first optical element 20 is not limited to the example in which it is constituted by such a hologram lens having the reflection diffraction action, and it may be constituted by a hologram lens having a transmission diffraction action. Although the hologram lens is an optical element having the collimation function and the deflection function, the first optical element 20 may be configured by combining a device having the collimation function and a device having the deflection function.

(Second Optical Element)

The light beam L1′ emitted from the first optical element 20 and the light beam L2′ emitted from the first optical element 20 at the angle different from that of the light beam L1′ enter the second optical element 30. The second optical element 30 includes a reflective deflection lens element that causes the light beam L1′ and the light beam L2′ to be respectively emitted at different angles in a manner that depends on the difference in wavelength.

The second optical element 30 is typically disposed in front of the observer's eye. In this embodiment, the second optical element 30 is constituted by a laminated film of a deflection reflection layer 31 that causes the light beam L1′ to concentrate on a light concentration axis C1 and a deflection reflection layer 32 that causes the light beam L2′ to concentrate on a light concentration axis C2. That is, the deflection reflection layer 31 has deflection selectivity to the light beam L1′ and the deflection reflection layer 32 has deflection selectivity to the light beam L2′.

The order of stacking of the respective deflection reflection layers 31 and 32 is not limited to the example shown in the figure, and can be arbitrarily set. Alternatively, the second optical element 30 may be constituted by a single deflection reflection layer having the functions of the respective deflection reflection layers 31 and 32.

The light concentration axis C1 are the light concentration axis C2 are parallel to each other and are set at different positions in a manner that depends on the difference between the respective incident positions of the light beam L1′ and the light beam L2′. The focal distance of the light beam L1′ and the focal distance of the light beam L2′ are identical to each other. The distance (amount of offset) between the light concentration axis C1 and the light concentration axis C2 is not particularly limited, and is, for example, 1 mm or more and 2 mm or less. Accordingly, the eye-box which is a range in which the image can be viewed when a pupil Ep of the observer moves in a direction of offset of the light concentration axes C1 and C2 can be enlarged.

A direction of offset of the light concentration axes C1 and C2 may be a horizontal direction as viewed from the eyeball E of the observer or may be a vertical direction as viewed from the eyeball E of the observer. For example, in a case where the image display apparatus 100 is applied to a head-mounted display (see FIG. 5) to be described later, the direction of offset of the light concentration axes C1 and C2 may be determined considering the shape of the display unit, a direction of displacement of mounting, and the like. In the example shown in FIG. 1, the light concentration axes C1 and C2 are offset so as to be deviated in the horizontal direction (X-axis direction) of the eyeball E.

The second optical element 30 is constituted by a translucent hologram combiner lens having wavelength selectivity. The deflection reflection layer 31 has the same diffraction characteristic as the deflection reflection layer 21 in the first optical element 20. The deflection reflection layer 32 has the same diffraction characteristic as the deflection reflection layer 22 in the first optical element 20. Since the second optical element 30 is configured as the combiner lens, images respectively formed by the light beam L1′ and the light beam L2′ are projected overlapping an external field of view observed through the second optical element 30.

[Image Display Method]

Next, a typical operation of the image display apparatus 100 according to this embodiment will be described.

The image display apparatus 100 causes the light beam L1 (first light beam) and the light beam L2 (second light beam) having the optical characteristics different from each other to simultaneously enter the first optical element 20, to thereby form the light beam L1′ (third light beam) emitted from the first optical element 20 and corresponding to the light beam L1 and the light beam L2′ (fourth light beam) emitted from the first optical element 20 at the angle different from that of the light beam L1′ and corresponding to the light beam L2. The image display apparatus 100 causes the light beam L1′ and the light beam L2′ to enter the second optical element 30, to thereby concentrate the light beam L1′ and the light beam L2′ at the pupil locations different from each other.

The optical engine 10 simultaneously emits the light beam L1 emitted from the first light source 11 and the light beam L2 emitted from the second light source 12 to the first optical element 20 while the scan mirror 15 scans those beams.

The light beam L1 and the light beam L2 simultaneously enter the same position in the first optical element 20. The light beam L1 is diffracted on the deflection reflection layer 21 of the first optical element 20 and enters the second optical element 30 as the light beam L1′. The light beam L2 is diffracted on the deflection reflection layer 22 of the first optical element 20 and enters the second optical element 30 as the light beam L2′. The light beam L1′ and the light beam L2′ are emitted from the first optical element 20 at angles different from each other, and therefore enter different positions on the second optical element 30.

The light beam L1′ and the light beam L2′ are propagated through the air (free space) between the first optical element 20 and the second optical element 30. Not limited thereto, the light beam L1′ and the light beam L2′ may be transmitted via a light transmitting member disposed between the first optical element 20 and the second optical element 30 as will be described later.

The second optical element 30 diffracts the light beam L1′ at the deflection reflection layer 31, to thereby project reproduction image light beams S1 deriving from the light beams L1 and L1′ onto the eyeball E. Moreover, the second optical element 30 diffracts the light beam L2′ at the deflection reflection layer 32, to thereby project reproduction image light beams S2 deriving from the light beams L2 and L2′ onto the eyeball E.

FIG. 3 is a schematic diagram showing the respective spot positions of the reproduction image light beams S1 and S2 projected onto the eyeball E. FIG. 3(A) shows a state in which the reproduction image light beams S1 are projected onto the pupil Ep of the eyeball E and the reproduction image light beams S2 are projected onto a position on the eyeball E, which is different from that of the pupil Ep.

At this time, the observer acquires information from an image displayed by the first reproduction image light beams S1. When the pupil Ep in this state moves to the left in the figure, information is acquired from the image displayed by the reproduction image light beams S2 instead of the image displayed by the reproduction image light beams S1. The image displayed by the reproduction image light beams S1 and the image displayed by the reproduction image light beams S2 are both identical, and therefore for the observer, the range (eye-box) in which the image can be viewed is enlarged, and disappearance of the image due to a slight movement of the pupil Ep or the line of sight can be prevented.

On the other hand, FIG. 3 (B) shows a state in which both the reproduction image light beams S1 and S2 are not projected onto the pupil Ep. For example, when the observer moves the pupil Ep upward in the figure (Y-axis direction) in a predetermined amount or more, the images displayed by the reproduction image light beams S1 and S2 are not visually recognized. In this manner, the display/non-display of the images is switched in accordance with a line-of-sight direction of the observer.

As described above, in accordance with the image display apparatus 100 according to this embodiment, the relationships between the angles of the scan mirror 15 (incident positions or incident angles of the light beam L1 and the light beam L2 with respect to the first optical element 20) and the angles of view of the reproduction image light beam S1 and S2 emitted from the second optical element 30 are identical.

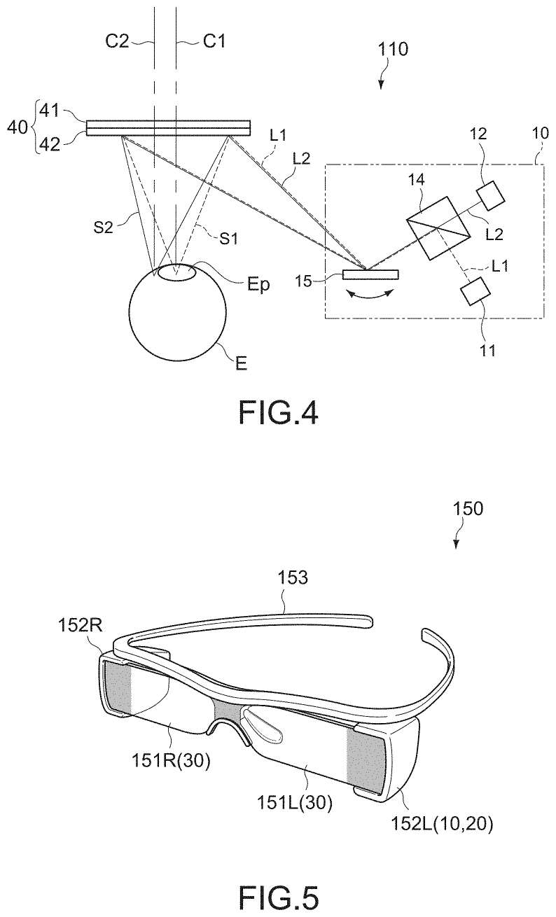

Accordingly, the light beam L1′ (reproduction image light beams S1) and the light beam L2′ (reproduction image light beam S2) can be concentrated at different pupil locations without the need for modulation of the light beam L1 and the light beam L2. Hereinafter, a description will be given as compared to an image display apparatus 110 shown in FIG. 4.

FIG. 4 is a schematic configuration diagram showing the image display apparatus 110 according to a comparison example. The image display apparatus 110 according to the comparison example includes a translucent hologram combiner lens 40 that concentrates two light beams L1 and L2 having wavelengths different from each other at the eyeball E of the observer as image reproduction light beams S1 and S2, respectively. The hologram combiner lens 40 includes a deflection reflection layer 41 that selectively diffracts the light beam L1 to thereby emit the image reproduction light beam S1 and a deflection reflection layer 42 that selectively diffracts the light beam L2 to thereby emit the reproduction image light beams S2. That is, the image display apparatus 110 according to the comparison example does not include the first optical element 20 in the image display apparatus 100 according to this embodiment and is configured to directly emit the light beams L1 and L2 emitted from the optical engine 10 to the hologram combiner lens 40.

In the image display apparatus 110 according to the comparison example, irradiation regions of the light beam L1 and the light beam L2 each scanned by the scan mirror, which are on the hologram combiner lens 40, are the same region as each other. However, the angle of the scan of the scan mirror 15, which enables the light beams L1 and L2 concentrated at the pupil Ep by the respective deflection reflection layers 41 and 42 to have the same angle of view, differs for each of the light beams L1 and L2. Therefore, if a partial region of an image formed by one light beam is drawn while the output of the other light beam is attenuated (or stopped), a part of an image formed by the other light beam can be simultaneously displayed in the image formed by the one light beam. Therefore, in the image display apparatus 110 according to the comparison example, in order to make the images formed by the light beams having the respective wavelengths L1 and L2 match with each other at different pupil locations, it is necessary to individually adjust the modulation timings of the light beams L1 and L2, which makes the image generation process complicated.

In contrast, the image display apparatus 100 according to this embodiment includes the first optical element 20 that the light beams L1 and L2 each emitted from the optical engine 10 enter and that emits them toward the second optical element 30 at different angles. Therefore, the irradiation regions of the light beam L1 and the light beam L2 on the second optical element 30 are regions different from each other while they have a region overlapping each other. Therefore, the relationships between the angles of the scan mirror 15 (incident positions or incident angles of the light beam L1 and the light beam L2 with respect to the first optical element 20) and the angles of view of the light beam L1′ and the light beam L2′ emitted from the second optical element 30 are identical.

Therefore, in accordance with this embodiment, the images formed by the light beams having the respective wavelengths L1 and L2 can be made to match with each other at different pupil locations without individually adjusting the modulation timings of the respective light beams L1 and L2. Accordingly, the image generation process that can more easily enlarge the eye-box than the comparison example can be realized.

[Application Example]

FIG. 5 is a perspective view of an overall head-mounted display 150 including the image display apparatus according to this embodiment. As shown in the figure, the head-mounted display 150 includes display units 151L and 151R and optical units 151L and 152R and a frame unit 153 that supports them.

The display units 151L and 151R are light-transmissive optical elements arranged in front of the eyes of a user (observer). The display unit 151L faces the left eye and the display unit 151R faces the right eye. The display units 151L and 151R may be integrally configured or may be each configured as a separate part. The display units 151L and 151R correspond to the second optical element 30 in the image display apparatus 100.

The optical units 152L and 152R are blocks that emit image light beams to the display units 151L and 151R. The optical units 152L and 152R are arranged at the rim of the display units 151L and 151R and include built-in optical elements corresponding to the optical engine 10 and the first optical element 20 in the image display apparatus 100.

Regarding the optical units 152L and 152R, it is sufficient to provide at least one of them. The head-mounted display 150 is configured such that the reproduction image light beam is projected onto the eyeball of the user from at least one of the display unit 151L or 151R.

### Second Embodiment

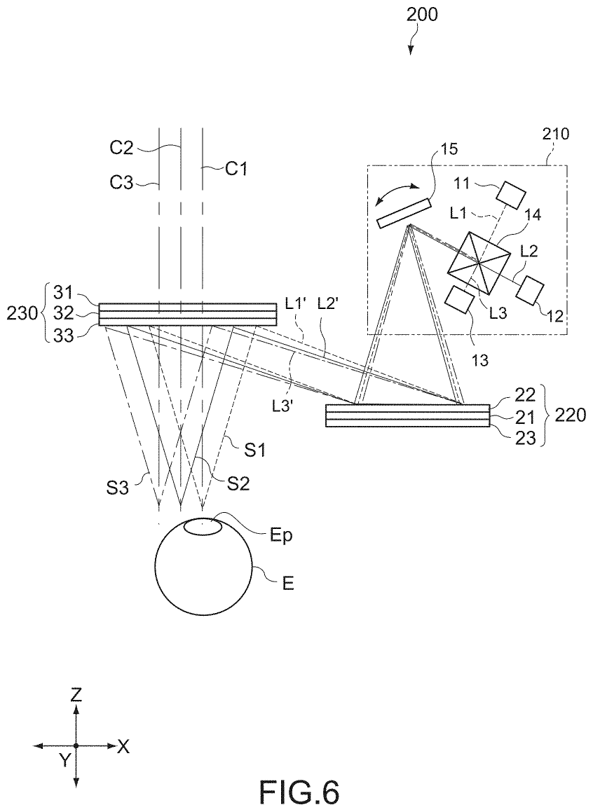

FIG. 6 is a schematic configuration diagram showing an image display apparatus 200 according to a second embodiment of the present technology. Hereinafter, configurations different from those of the first embodiment will be mainly described, configurations similar to those of the first embodiment will be denoted by similar reference signs, and descriptions thereof will be omitted or simplified.

Configurations of an optical engine 210, a first optical element 220, and a second optical element 230 in the image display apparatus 200 according to this embodiment are different from those of the first embodiment. In this embodiment, the optical engine 210 further includes a third light source 13 that emits a laser light beam L3 (fifth light beam) having a wavelength A3 (third wavelength) different from the wavelength λ1 and the wavelength λ2 as the center wavelength and the dichroic mirror 14 is configured to be capable of combining light beams L1 to L3 emitted from the first to third light sources 11 to 13.

The first optical element 220 further includes a deflection reflection layer 23 that the light beam L3 emitted from the optical engine 10 enters, in addition to the deflection reflection layers 21 and 22. The deflection reflection layer 23 is a reflective hologram that is an optical element that emits a light beam L3′ (sixth light beam) corresponding to the light beam L3 at an angle different from the light beam L1′ and the light beam L2′.

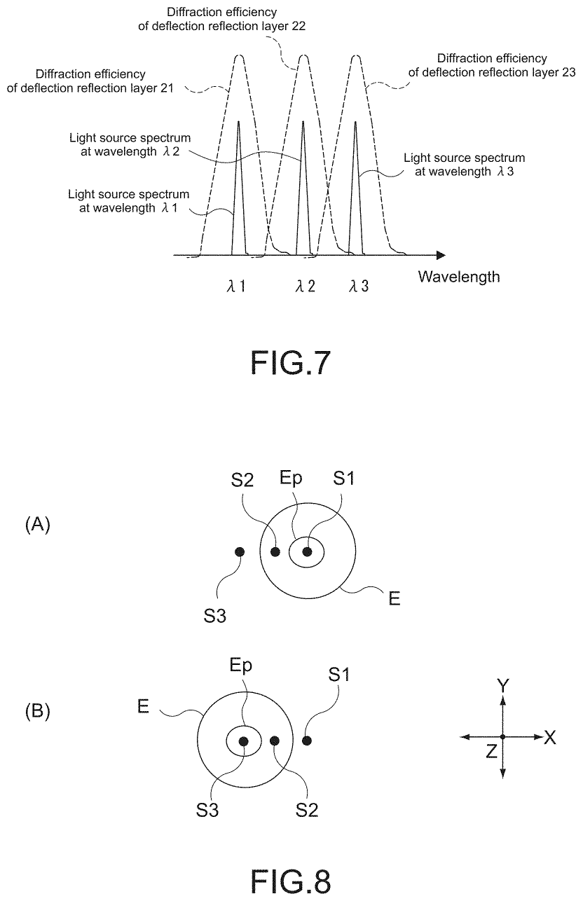

FIG. 7 is a diagram describing diffraction characteristics of the first optical element 220. As shown in the figure, the deflection reflection layer 23 is a reflective hologram having wavelength selectivity to provide highest diffraction efficiency to the light beam L1 having the wavelength A3. Although a wavelength longer than the wavelength λ2 is selected as the wavelength A3, a wavelength shorter than the wavelength λ1 may be selected or the wavelength between the wavelength λ1 and the wavelength λ2 may be selected.

The order of stacking of the respective deflection reflection layers 21 to 23 is not limited to the example shown in the figure, and can be arbitrarily set. Moreover, the first optical element 220 may be constituted by a single deflection reflection layer having the functions of the respective deflection reflection layers 21 to 23.

The second optical element 230 further includes a deflection reflection layer 33 serving as a deflection lens element that causes the light beam L3′ emitted from the first optical element 220 to concentrate on a light concentration axis C3 different from the light concentration axes C1 and C2 as a reproduction image light beam S3, in addition to the deflection reflection layers 31 and 32.

The order of stacking of the respective deflection reflection layers 31 to 33 is not limited to the example shown in the figure, and can be arbitrarily set. Moreover, the second optical element 230 may be constituted by a single deflection reflection layer having the functions of the respective deflection reflection layers 31 to 33.

The light concentration axis C3 is parallel to the light concentration axes C1 and C2 and may be arranged in the arrangement direction of the light concentration axes C1 and C2 or may be arranged at a position different from that in the arrangement direction of the light concentration axes C1 and C2.

FIG. 8(A) and (B) are diagrams showing a relationship between the eyeball E and a spot position of each reproduction image light beam S1, S2, or S3 and show an example in which the light concentration axes C1 to C3 are arranged in the horizontal direction (X-axis direction) of the eyeball E. In accordance with this example, the range of the pupil Ep in the horizontal direction, in which the image can be recognized, is widened, and therefore enlargement of the eye-box in the horizontal direction can be achieved.

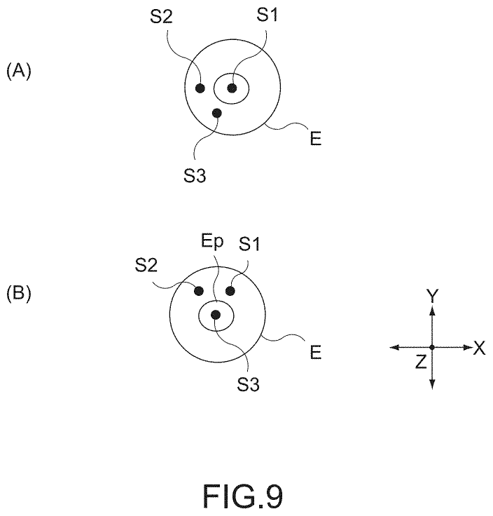

On the other hand, FIG. 9(A) and (B) are diagrams showing a relationship between the eyeball E and a spot position of each reproduction image light beam S1, S2, or S3 and show an example in which the light concentration axis C3 is arranged at a position offset in the vertical direction (Y-axis direction) of the eyeball E, which is different from the arrangement direction of the light concentration axes C1 and C2. In accordance with this example, the range of the pupil Ep, in which the image can be recognized, can be widened not only in the horizontal direction but also in the vertical direction, and therefore enlargement of the eye-box in those respective directions can be achieved.

The number of light beams having different wavelengths emitted from the optical engine 10 may be four. In this case, providing the first optical element and the second optical element with four or more deflection reflection layers having wavelength selectivity to the light beam having each wavelength can widen the eye-box in an arbitrary direction to have an arbitrary size.

### Third Embodimen

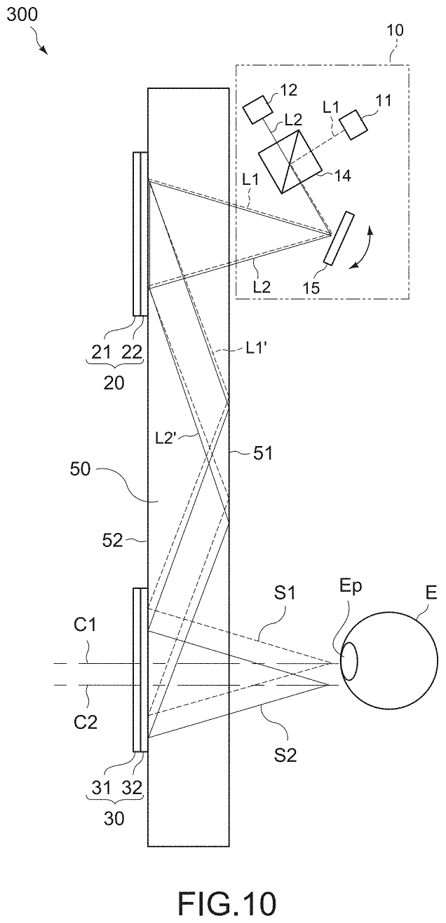

FIG. 10 is a schematic configuration diagram showing an image display apparatus 300 according to a third embodiment of the present technology. Hereinafter, configurations different from those of the first embodiment will be mainly described, configurations similar to those of the first embodiment will be denoted by similar reference signs, and descriptions thereof will be omitted or simplified.

Regarding the image display apparatus 300 according to this embodiment, it is different from the first embodiment in that it includes a light transmitting member 50 that transmits the light beam L1′ (third light beam) and the light beam L2′ (fourth light beam) to the second optical element 30 from the first optical element 20.

In this embodiment, the light transmitting member 50 is a light guiding plate that integrally supports the first optical element 20 and the second optical element 30. The light transmitting member 50 includes a first surface 51 that the light beams L1 and L2 enter from the optical engine 10 and a second surface 52 that supports the first optical element 20 and the second optical element 30. The light transmitting member 50 is constituted by a light-transmissive material such as glass and synthetic resin material. The light transmitting member 51 is not limited to the planar shape as shown in the figure, and it may have a curved surface shape.

The first optical element 20 and the second optical element 30 are each bonded to the second surface 52 of the light transmitting member 50 via a light-transmissive bonding material. The first optical element 20 diffracts the light beams L1 and L2 that enter from the first surface 51 as the light beams L1′ and L2′. The light beams L1′ and L2′ are totally reflected on the first surface 51 and enter the second optical element 30. The second optical element 30 diffracts the light beams L1′ and L2′ and concentrates them at different pupil locations in the eyeball E as the image reproduction light beams S1 and S2, respectively.

The number of times of total reflection of the light beams L1′ and L2′ in the light transmitting member 50 is not limited to one, and the light beams L1′ and L2′ may be totally reflected two or more times. The second optical element 30 may be disposed on the first surface 51 of the light transmitting member 50 in a manner that depends on paths of the light beams L1′ and L2′. In this case, the image reproduction light beams S1 and S2 may be emitted from the second surface 52.

In the image display apparatus 300 according to this embodiment, the light transmitting member 50 that commonly supports the first optical element 20 and the second optical element 30 is provided, and therefore the mounting reliability of the first optical element 20 and the second optical element 30 can be improved and the degree of freedom of design of the optical system can be enhanced. It should be noted that another light transmitting member such as optical fibers may be used as the light transmitting member 50.

### Fourth Embodiment

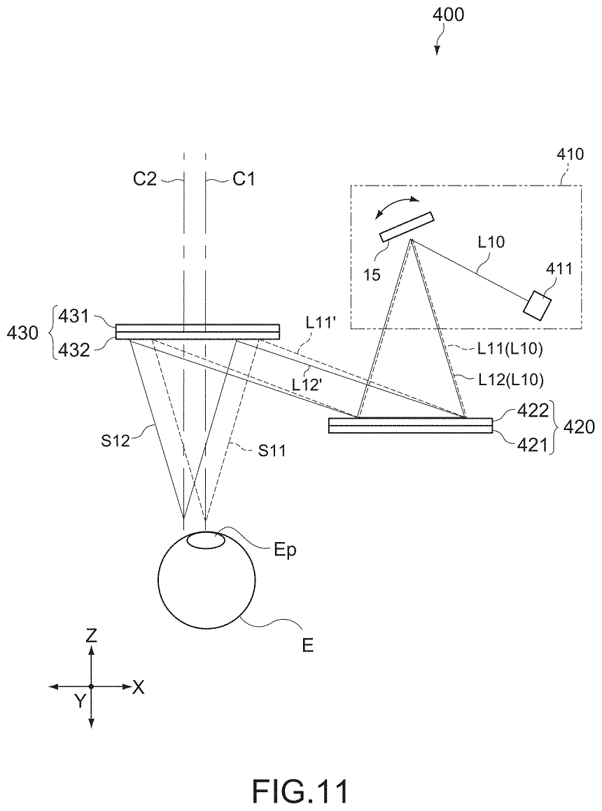

FIG. 11 is a schematic configuration diagram showing an image display apparatus 400 according to a fourth embodiment of the present technology. Hereinafter, configurations different from those of the first embodiment will be mainly described, configurations similar to those of the first embodiment will be denoted by similar reference signs, and descriptions thereof will be omitted or simplified.

Regarding the image display apparatus 400 according to this embodiment, it is different from the first embodiment in that a first optical element 420 and a second optical element 430 are constituted by optical elements each having polarization dependency.

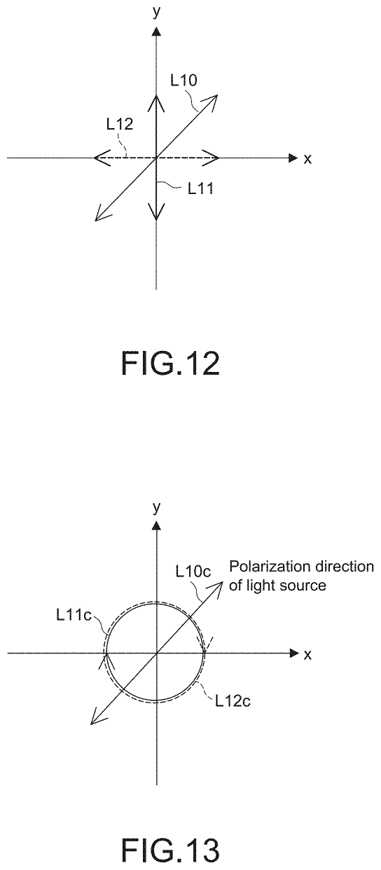

An optical engine 410 has a single light source 411. The light source 411 emits a light beam L10 that is a single-wavelength laser light beam having polarization characteristics divisible into two linearly polarized light beams L11 (first polarized component) and L12 (second polarized component) that are orthogonal to each other as shown in FIG. 12. The light beam L10 is scanned onto the first optical element 420 by the scan mirror 15.

The first optical element 420 is constituted by an optical element having polarization dependency or polarization selectivity that collimates a light beam L0, deflects the one linearly polarized component L11 (first light beam) as a light beam L11′ (third light beam) and deflects the other linearly polarized component L12 (second light beam) as a light beam L12′ (fourth light beam). That is, the first optical element 420 has the functions of dividing the incident light beam LO into two light beams L11′ and L12′ in accordance with polarized components.

In this embodiment, the first optical element 420 is constituted by a laminate of a deflection reflection layer 421 that emits the light beam L11′ by selectively diffracting the linearly polarized component L11 and a deflection reflection layer 422 that emits the light beam L12′ at an angle different from the light beam L11′ by selectively diffracting a linearly polarized component L112.

Although each of the deflection reflection layers 421 and 422 is constituted by a reflective hologram lens, it may be constituted by a transmissive hologram lens. The order of stacking of the respective deflection reflection layers 421 and 422 is not limited to the example shown in the figure, and can be arbitrarily set. Moreover, the first optical element 420 may be constituted by a single deflection reflection layer having the functions of the respective deflection reflection layers 421 and 422.

The second optical element 430 is constituted by an optical element (typically, a hologram combiner lens) having polarization dependency or polarization selectivity, which the light beam L11′ and the light beam L12′ emitted from the first optical element 420 enter, and that concentrates the light beam L11′ and the light beam L12′ at pupil locations different from each other in accordance with the differences in the polarization characteristics. In this embodiment, the second optical element 430 is constituted by a laminate of a deflection reflection layer 431 that emits the light beam L11′ onto the light concentration axis C1 as an image reproduction light beam S11 by selectively diffracting the light beam L11′ and a deflection reflection layer 432 that emits the light beam L12′ onto the light concentration axis C2 as an image reproduction light beam S12 by selectively diffracting the light beam L12′.

The order of stacking of the respective deflection reflection layers 431 and 432 is not limited to the example shown in the figure, and can be arbitrarily set. Moreover, the second optical element 430 may be constituted by a single deflection reflection layer having the functions of the respective deflection reflection layers 431 and 432.

Also with the image display apparatus 400 according to this embodiment configured in the above-mentioned manner, actions and effects similar to those of the first embodiment can be provided. In accordance with this embodiment, two reproduction images can be drawn by the single light source 411, and therefore simplification of the configuration of the optical engine 410, a reduction of the number of components, and the like can be achieved.

It should be noted that the first and second polarized components are not limited to the linearly polarized light beams, and may be circularly polarized light beams opposite in rotational direction to each other. In this case, as shown in FIG. 13, the light source 411 is configured to emit a light beam L10c divisible into a circularly polarized light beam L11c which is right-handed and a circularly polarized component L12c which is left-handed. In this case, the respective deflection reflection layers 421 and 422 in the first optical element 420 and the respective deflection reflection layers 431 and 432 in the second optical element 430 are constituted by hologram lenses or the like that selectively diffract those circularly polarized light beams L11c and L12c. The circularly polarized light beams L11c and L12c may be elliptically polarized light beams.

### Fifth Embodiment

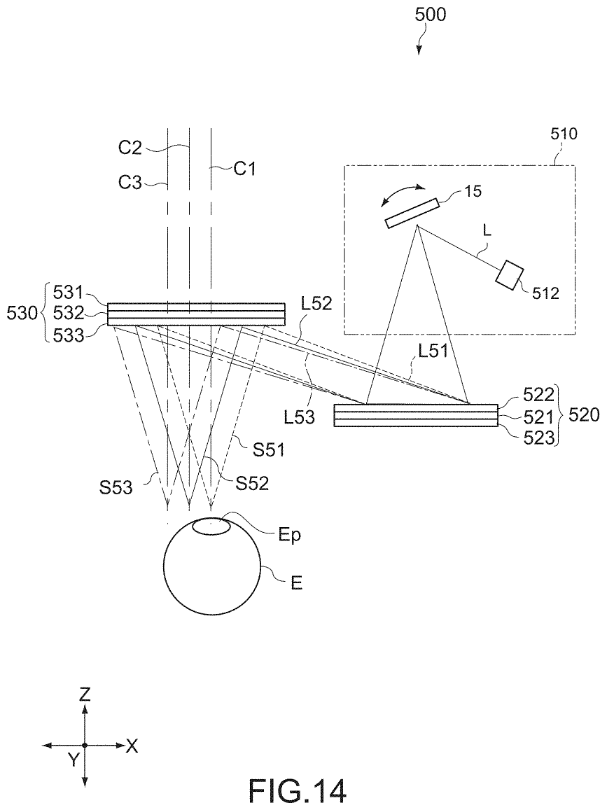

FIG. 14 is a schematic configuration diagram showing an image display apparatus 500 according to a fifth embodiment of the present technology. Hereinafter, configurations different from those of the first embodiment will be mainly described, configurations similar to those of the first embodiment will be denoted by similar reference signs, and descriptions thereof will be omitted or simplified.

Regarding the image display apparatus 500 according to this embodiment, it is different from the first embodiment in that a first optical element 520 and a second optical element 530 are constituted by optical elements each having dependency on incident angles of light beams.

The optical engine 410 has a single light source 411. The light source 511 emits a light beam L that is a single-wavelength laser light beam. The light beam L is scanned onto the first optical element 520 by the scan mirror 15.

The first optical element 520 includes a plurality of optical elements each having a different diffraction characteristic to an incident angle of an incident light beam. In this embodiment, the first optical element 520 includes a plurality of deflection reflection layers that emits diffracted light beams when the light beam L enters at a predetermined incident angle, and each of the deflection reflection layers has a different incident angle of the light beam L for which the deflection reflection layer emits a diffracted light beam. Each of the deflection reflection layers is typically constituted by a hologram lens layer.

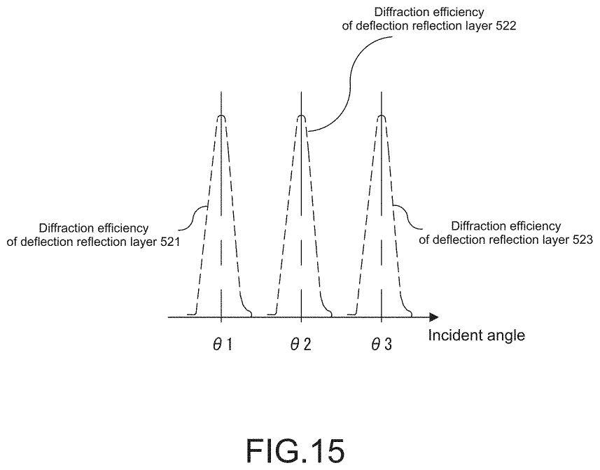

The first optical element 520 includes deflection reflection layers 521 to 523 of three layers having the diffraction efficiency as shown in FIG. 15. The first deflection reflection layer 521 emits a diffracted light beam L51 when the incident angle of the light beam L is a first angle 01. The second deflection reflection layer 522 emits a diffracted light beam L52 when the incident angle of the light beam is a second angle θ2. The third deflection reflection layer 523 emits a diffracted light beam L53 when the incident angle of the light beam is a third angle θ3. The angles θ1, θ2, and θ3 are angles different from each other. The respective angles θ1, θ2, and θ3 may be a single angle or may include a plurality of angles. Each of the diffracted light beams L51, L52, and L53 may be emitted at a different angle.

The second optical element 530 is constituted by an optical element (typically, a hologram combiner lens) that a plurality of diffracted light beams emitted from the first optical element enters and that concentrates the plurality of diffracted light beams at different pupil locations.

In this embodiment, the second optical element 530 is constituted by a laminate of deflection reflection layers 531 to 533 which are three layers that cause each of the diffracted light beams L51, L52, and L53 to concentrate on a predetermined light concentration axis. The first deflection reflection layer 531 causes the light beam L51 to concentrate on the light concentration axis C1, the second deflection reflection layer 532 causes the light beam L52 to concentrate on the light concentration axis C2, and the third the deflection reflection layer 533 causes the light beam L53 to concentrate on the light concentration axis C3. The order of stacking of the respective deflection reflection layers 531 to 533 is not limited to the example shown in the figure, and can be arbitrarily set.

Also in the image display apparatus 500 according to this embodiment configured in the above-mentioned manner, actions and effects similar to the first embodiment can be obtained. In accordance with this embodiment, three reproduction images can be drawn by the single light source 511, and therefore simplification of the configuration of the optical engine 510, a reduction of the number of components, and the like can be achieved.

Moreover, the number of times of stacking of the deflection reflection layers that constitute the first optical element 520 and the second optical element 530 is not limited to the three layers, and two layers or four or more layers. The number of images to be reproduced can be arbitrarily adjusted by the number of times of stacking of those deflection reflection layers.

### Modified Examples

For example, in the above-mentioned embodiments, the image display apparatus that can be configured as the head-mounted display has been exemplified, though not limited thereto. The present technology can also be applied to another display such as a head-up display.

Moreover, in each of the image display apparatuses according to the fourth to sixth embodiments, propagation of light beams to the second optical element from the first optical element may be performed by using a light transmitting member such as a light guiding plate as in the third embodiment.

In addition, an optical element such as a reflection mirror may be additionally arranged between the first optical element and the second optical element. Accordingly, the degree of freedom of arrangement of the first optical element and the second optical element can be increased.

It should be noted that the present technology may also take the following configurations.

(1) An image display apparatus, including:

a first optical element that a first light beam and a second light beam having optical characteristics different from each other simultaneously enter; and

a second optical element that a third light beam emitted from the first optical element and corresponding to the first light beam and a fourth light beam emitted from the first optical element at an angle different from an angle of the third light beam and corresponding to the second light beam enter and that concentrates the third light beam and the fourth light beam at pupil locations different from each other.

(2) The image display apparatus according to (1), in which

the first optical element includes at least one optical element that collimates the first light beam and the second light beam, deflects the first light beam as the third light beam, and deflects the second light beam as the fourth light beam.

(3) The image display apparatus according to (2), in which

the first light beam and the second light beam have wavelengths different from each other, and

the first optical element and the second optical element includes the optical element having wavelength selectivity. (4) The image display apparatus according to (2), in which

the first light beam and the second light beam have polarization characteristics different from each other, and

the first optical element and the second optical element includes the optical element having polarization selectivity.

(5) The image display apparatus according to any one of (2) to (4), in which

the optical element is reflective.

(6) The image display apparatus according to any one of (2) to (5), in which

the first optical element and the second optical element are hologram lenses.

(7) The image display apparatus according to any one of (1) to (6), in which

the first optical element and the second optical element include a first deflection reflection layer and a second deflection reflection layer, and

the first deflection reflection layer has deflection selectivity to the first light beam and the second deflection reflection layer has deflection selectivity to the second light beam.

(8) The image display apparatus according to any one of (1) to (7), in which

the first optical element includes an optical element that a fifth light beam having an optical characteristic different from the optical characteristics of the first light beam and the second light beam enters and that causes a sixth light beam corresponding to the fifth light beam to be emitted at an angle different from the angles of the third light beam and the fourth light beam, and

the second optical element includes a deflection lens element that concentrates the third light beam, the fourth light beam, and the sixth light beam at the pupil locations different from each other.

(9) The image display apparatus according to any one of (1) to (8), further including

an optical engine that emits the first light beam and the second light beam toward the first optical element at a predetermined timing.

(10) The image display apparatus according to (9), in which

the optical engine includes
a first light source that emits, as the first light beam, a laser light beam having a first wavelength as a center wavelength, and
a second light source that emits, as the second light beam, a laser light beam having a second wavelength different from the first wavelength as a center wavelength.
   (11) The image display apparatus according to (10), in which

a difference between the first wavelength and the second wavelength is 50 nm or less.

(12) The image display apparatus according to (9), in which

the optical engine includes a light source that emits a single-wavelength laser light beam having polarization characteristics divisible into a first polarized component and a second polarized component by the first optical element.

(13) The image display apparatus according to (12), in which

the first polarized component and the second polarized component are linearly polarized light beams orthogonal to each other.

(14) The image display apparatus according to (12), in which

the first polarized component and the second polarized component are circularly polarized light beams opposite in rotational direction to each other.

(15) The image display apparatus according to any one of (9) to (14), in which

the optical engine includes a scan mirror that scans the first light beam and the second light beam on the first optical element.

(16) The image display apparatus according to any one of (1) to (15), further including

a light transmitting member that transmits the third light beam and the fourth light beam to the second optical element from the first optical element.

(17) An image display apparatus, including:

a first optical element including a plurality of optical elements each having a different diffraction characteristic to an incident angle of an incident light beam; and

a second optical element that a plurality of diffracted light beams emitted from the first optical element enters and that concentrates the plurality of diffracted light beams at pupil locations different from each other.

(18) An image display method, including:

causing a first light beam and a second light beam having optical characteristics different from each other to simultaneously enter a first optical element, to thereby form a third light beam emitted from the first optical element and corresponding to the first light beam and a fourth light beam emitted from the first optical element at an angle different from an angle of the third light beam and corresponding to the second light beam; and

causing the third light beam and the fourth light beam to enter a second optical element, to thereby concentrate the third light beam and the fourth light beam at pupil locations different from each other.

(19) A head-mounted display, including:

an optical engine that emits a first light beam and a second light beam having optical characteristics different from each other;

a first optical element that the first light beam and the second light beam simultaneously enter; and

a display unit that includes a second optical element that a third light beam emitted from the first optical element and corresponding to the first light beam and a fourth light beam emitted from the first optical element at an angle different from an angle of the third light beam and corresponding to the second light beam enter and that concentrates the third light beam and the fourth light beam at pupil locations different from each other.

### REFERENCE SIGNS LIST

10, 210, 410, 510 optical engine

11 first light source

12 second light source

13 third light source

15 scan mirror

20, 220, 420, 520 first optical element

21, 22, 23, 421, 422, 521, 522, 523 deflection reflection layer

31, 32, 33, 431, 432, 531, 532, 533 deflection reflection layer

30, 230, 430, 530 second optical element light transmitting member

100, 200, 300, 400, 500 image display apparatus

150 head-mounted display

151L, 151R display unit

C1, C2, C3 light concentration axis

E eyeball

L, L1, L1′, L2, L2′, L3, L3′ light beam

1. An image display apparatus, comprising:
a first optical element that a first light beam and a second light beam having optical characteristics different from each other simultaneously enter; and
a second optical element that a third light beam emitted from the first optical element and corresponding to the first light beam and a fourth light beam emitted from the first optical element at an angle different from an angle of the third light beam and corresponding to the second light beam enter and that concentrates the third light beam and the fourth light beam at pupil locations different from each other.

2. The image display apparatus according to claim 1, wherein
the first optical element includes at least one optical element that collimates the first light beam and the second light beam, deflects the first light beam as the third light beam, and deflects the second light beam as the fourth light beam.

3. The image display apparatus according to claim 2, wherein
the first light beam and the second light beam have wavelengths different from each other, and
the first optical element and the second optical element includes the optical element having wavelength selectivity.

4. The image display apparatus according to claim 2, wherein
the first light beam and the second light beam have polarization characteristics different from each other, and
the first optical element and the second optical element includes the optical element having polarization selectivity.

5. The image display apparatus according to claim 2, wherein the optical element is reflective.

6. The image display apparatus according to claim 2, wherein the first optical element and the second optical element are hologram lenses.

7. The image display apparatus according to claim 1, wherein
the first optical element and the second optical element include a first deflection reflection layer and a second deflection reflection layer, and
the first deflection reflection layer has deflection selectivity to the first light beam and the second deflection reflection layer has deflection selectivity to the second light beam.

8. The image display apparatus according to claim 1, wherein
the first optical element includes an optical element that a fifth light beam having an optical characteristic different from the optical characteristics of the first light beam and the second light beam enters and that causes a sixth light beam corresponding to the fifth light beam to be emitted at an angle different from the angles of the third light beam and the fourth light beam, and
the second optical element includes a deflection lens element that concentrates the third light beam, the fourth light beam, and the sixth light beam at the pupil locations different from each other.

9. The image display apparatus according to claim 1, further comprising
an optical engine that emits the first light beam and the second light beam toward the first optical element at a predetermined timing.

10 The image display apparatus according to claim 9, wherein
the optical engine includes
a first light source that emits, as the first light beam, a laser light beam having a first wavelength as a center wavelength, and
a second light source that emits, as the second light beam, a laser light beam having a second wavelength different from the first wavelength as a center wavelength.

11. The image display apparatus according to claim 10, wherein
a difference between the first wavelength and the second wavelength is 50 nm or less.

12. The image display apparatus according to claim 9, wherein
the optical engine includes a light source that emits a single-wavelength laser light beam having polarization characteristics divisible into a first polarized component and a second polarized component by the first optical element.

13. The image display apparatus according to claim 12, wherein
the first polarized component and the second polarized component are linearly polarized light beams orthogonal to each other.

14. The image display apparatus according to claim 12, wherein
the first polarized component and the second polarized component are circularly polarized light beams opposite in rotational direction to each other.

15. The image display apparatus according to claim 9, wherein
the optical engine includes a scan mirror that scans the first light beam and the second light beam on the first optical element.

16. The image display apparatus according to claim 1, further comprising
a light transmitting member that transmits the third light beam and the fourth light beam to the second optical element from the first optical element.

17. An image display apparatus, comprising:
a first optical element including a plurality of optical elements each having a different diffraction characteristic to an incident angle of an incident light beam; and
a second optical element that a plurality of diffracted light beams emitted from the first optical element enters and that concentrates the plurality of diffracted light beams at pupil locations different from each other.

18. An image display method, comprising:
causing a first light beam and a second light beam having optical characteristics different from each other to simultaneously enter a first optical element, to thereby form a third light beam emitted from the first optical element and corresponding to the first light beam and a fourth light beam emitted from the first optical element at an angle different from an angle of the third light beam and corresponding to the second light beam; and
causing the third light beam and the fourth light beam to enter a second optical element, to thereby concentrate the third light beam and the fourth light beam at pupil locations different from each other.

19. A head-mounted display, comprising:
an optical engine that emits a first light beam and a second light beam having optical characteristics different from each other;
a first optical element that the first light beam and the second light beam simultaneously enter; and
a display unit that includes a second optical element that a third light beam emitted from the first optical element and corresponding to the first light beam and a fourth light beam emitted from the first optical element at an angle different from an angle of the third light beam and corresponding to the second light beam enter and that concentrates the third light beam and the fourth light beam at pupil locations different from each other.
